(19) United States
(12) Patent Application Publication
(10) Pub. No.: US 2015/0120408 A1
(43) Pub. Date: Apr. 30, 2015

(54) METHOD AND APPARATUS FOR PROXIMITY-AWARE ADAPTATION OF APPLICATIONS, CONTENT, AND USER INCENTIVES

(71) Applicants: Huanglingzi Liu, Beijing (CN); Xu Jia, Beijing (CN); Huanhuan Cao, Beijing (CN); Yongguang Guo, Beijing (CN); Ying Liu, Beijing (CN)

(72) Inventors: Huanglingzi Liu, Beijing (CN); Xu Jia, Beijing (CN); Huanhuan Cao, Beijing (CN); Yongguang Guo, Beijing (CN); Ying Liu, Beijing (CN)

(73) Assignee: NOKIA CORPORATION, Espoo (FI)

(21) Appl. No.: 14/399,511

(22) PCT Filed: May 16, 2012
(86) PCT No.: PCT/CN2012/075608

§ 371 Date: Nov. 6, 2014

(51) Int. Cl. G06Q 30/02

(52) U.S. Cl. CPC G06Q 30/0209; G06Q 30/0261
USPC 705/14.12

(57) ABSTRACT

An approach is provided for determining proximity of a user to a POI to dynamically adapt applications, content, and user incentive. One or more service providers determine a proximity of at least one device to at least one point of interest and determine at least one difficulty level associated with at least one application, at least one content item, or a combination thereof based, at least in part, on the proximity.

### BACKGROUND

Service providers and device manufacturers (e.g., wireless, cellular, etc.) are continually challenged to deliver value and convenience to consumers by, for example, providing compelling network services. One area of focus is the development of services and technologies for delivering location-based services (e.g., advertising, incentives, offers, discounts, marketing, etc.) via applications and contents (e.g., games, media, etc.) to a device (e.g., a user) that depend on, for example, verifying that the device receiving the location-based services is physically located at or is in close proximity to a point of interest (e.g., a merchant, a business, etc.). Further, the service providers need an effective mechanism to combine delivery of user incentives with applications and content to a device. Accordingly, service providers and device manufacturers are challenged to develop accurate and efficient mechanisms for delivering merchant information and compelling user incentives to the users.

### SOME EXAMPLE EMBODIMENTS

Therefore, there is a need for an approach for determining proximity of a user to a POI to dynamically adapt applications, content, and user incentive.

According to one embodiment, a method comprises determining a proximity of at least one device to at least one point of interest. The method also comprises determining at least one difficulty level associated with at least one application, at least one content item, or a combination thereof based, at least in part, on the proximity.

According to another embodiment, an apparatus comprises at least one processor and at least one memory including computer program code for one or more programs, the at least one memory and the computer program code configured to, with the at least one processor, cause the apparatus to determine a proximity of at least one device to at least one point of interest. The apparatus is also caused to determine at least one difficulty level associated with at least one application, at least one content item, or a combination thereof based, at least in part, on the proximity.

According to another embodiment, a computer-readable storage medium carries one or more sequences of one or more instructions which, when executed by one or more processors, cause, at least in part, an apparatus to determine a proximity of at least one device to at least one point of interest. The apparatus is also caused to determine at least one difficulty level associated with at least one application, at least one content item, or a combination thereof based, at least in part, on the proximity.

According to another embodiment, an apparatus comprises means for determining a proximity of at least one device to at least one point of interest. The apparatus also comprises means for determining at least one difficulty level associated with at least one application, at least one content item, or a combination thereof based, at least in part, on the proximity.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-30, and 51-53.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining proximity of a user to a POI and dynamically adapt applications, content, and user incentive, according to an embodiment;

FIG. 2 is a diagram of the components of a processing platform, according to an embodiment;

FIG. 3 is a diagram of the components of a user equipment, according to an embodiment;

FIG. 4 is a flowchart of a process for determining location information and difficulty level, according to an embodiment;

FIG. 5 is a flowchart of a process for searching for a point of interest and presenting a recommendation, according to an embodiment;

FIG. 6 is a flowchart of a process for determining a difficult level based on one or more parameters, according to an embodiment;

FIG. 7 is a flowchart of a process for determining proximity of a user to a point of interest adjusting a difficulty level accordingly, according to an embodiment;

FIGS. 8A-8G are diagrams and user interfaces utilized in the processes of FIGS. 4-7, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for determining proximity of a user to a POI to dynamically adapt applications, content, and user incentive. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

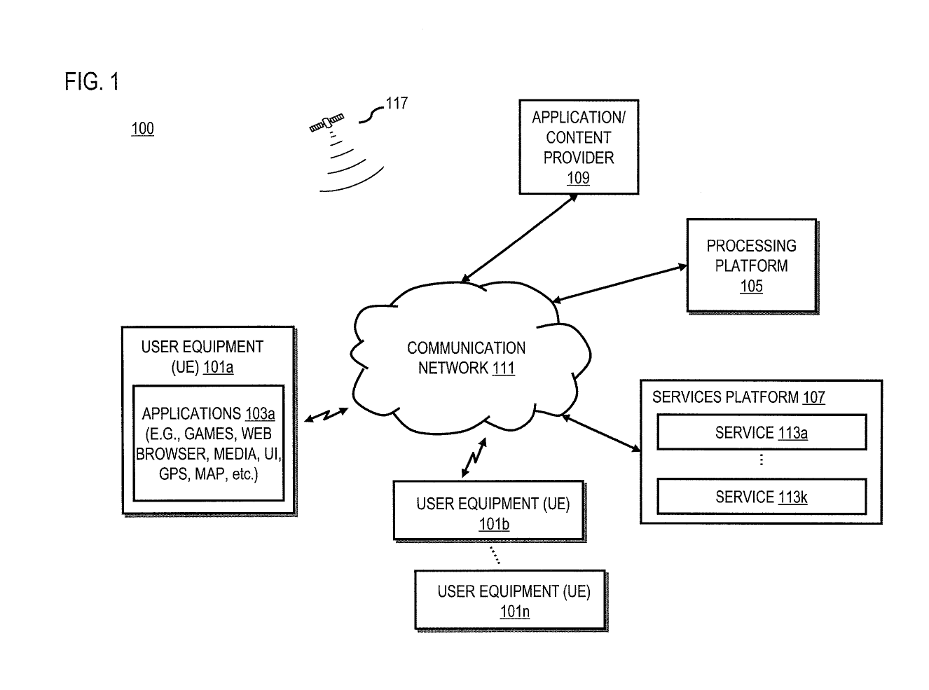

FIG. 1 is a diagram of a system capable of determining proximity of a user to a POI and dynamically adapting applications, content, and user incentive, according to an embodiment. As mentioned, service providers need an efficient method for promoting services and products to potential customers offered at various points of interest (POIs) by various merchants/businesses. In one instance, a service provider may utilize various information such as a device/user location, user activity, a user profile, user preferences, and the like, that are associated with a potential customer to trigger delivery of the POI information such as promotional information, which may include for example, any data for indicating details regarding one or more products, goods, services or a combination thereof. This may include for example, pricing data, product details, manufacturing details, availability, a discount, an offer, a coupon, an incentive, and the like. Further, the promotional information may be delivered to the users and devices via various mediums such as one or more applications (e.g., an electronic game), one or more content items (e.g., a short story), and the like. On area of interest has been development of electronic game applications which utilize user location information (e.g., real time) to include in the game, to adjust/modify one or more parameters of the game, to deliver one or more promotional information items (e.g., incentives, coupons) to the user, and the like. However, in-game advertising methods may attempt to display the promotional information in the background of a game application, for example, as a billboard or a commercial during a pause (e.g., created by the user and/or the game application), which may not be as effective since it may not necessarily interest the user. For example, a user may not be interested in a promotional pop-up (e.g., a coupon) associated with a near-by restaurant or a coffee shop while he is playing a game on the device and/or online. Therefore, there is a need for a mechanism to utilize location and user information of a device for determining and delivering user incentives that would be closely associated with the user's interests, the applications, and/or content items being utilized/consumed by the user.

To address, at least these problems, a system 100 of FIG. 1 introduces the capability for determining proximity of a user to a POI and dynamically adapt applications, content, and user incentive. By way of example, in the system 100 a service provider may determine that a user is utilizing an application (e.g., an electronic game) and/or is consuming a content item (e.g., reading a poem) at a particular physical location. Further, a service provider can determine one or more POIs (e.g., merchants) who may wish to provide promotional information (e.g., coupons, discounts) via the application and/or the content item to the user, wherein the POIs may be in close proximity to the user's location. Further, the service provider (e.g., a processing platform, a content provider, etc.) may determine one or more parameters associated with the application and/or the content item, which may be adjusted/modified such that it would render the application and/or the content item more interesting (e.g., an easier level, more challenging, added game points, etc.) for the user, while suggesting one or more user actions (e.g., travel along a certain path, go to a POI) in order for the user to receive the adjustment/modification to the application and/or to the content item. For example, difficulty level of a game application may be dynamically changed for the purpose of attracting the user (e.g., game player) to a POI (e.g., a coffee shop) while maintaining user interest and anticipation as the user is travelling closer to the POI.

In one embodiment, a merchant wishing to attract consumers (e.g., users) to his business location registers his business information with one or more service providers, wherein the business information may include information on business location, offered services/products, scope of target consumers (e.g., demographics, distance from the business location, etc.), available incentives, and the like. In one embodiment, the one or more service providers (e.g., a processing platform) may process the registered business information in order to determine one or more criteria for determining suitable consumers for the merchant as well as determining one or more applications, content items, incentives, and the like that would be of interest to the suitable consumers. In one embodiment, the one or more service providers determine location of one or more devices (e.g., users), determine one or more applications and/or content items being utilized/consumed at the one or more devices (e.g., by the users), determine one or more points of interest (POIs) (e.g., merchants) in proximity to the one or more devices. Further, the one or more service providers determine one or more criteria based, at least in part, on the one or more POI information for determining one or more suitable consumers for the one or more merchants and determine one or more adjustments and/or parameters for the one or more applications and/or the content items being utilized/consumed at the one or more devices. In general, various electronic games include various challenge levels (e.g., 1, 2, 3, beginner, expert, etc.), various methods for a user (e.g., a player) to collect game incentives (e.g., points, virtual prizes, virtual ammunition, etc.) For example, it may take several attempts for a player to achieve a certain level in a certain game, or be able to upgrade virtual equipment (e.g., vehicles, planes, guns, etc.) utilized in that certain game. In one example, a player may not be able to pass a certain level in a given game before collecting certain number of points, discovering certain clues, determining certain secret codes, and the like. In one example, a consumer may be reading a textual content item (e.g., a poem), which may be difficult to follow/comprehend. In one embodiment, the service provider may determine that a user is at a certain location and is playing an electronic game (e.g., online, on the device) and that the user may be interested in one or more game incentives associated with the game currently in use; for example, the user is unable to pass a certain level in the game and may be interested in receiving some game points that would help in transitioning to an easier level. Further, the one or more service providers may determine one or more POIs (e.g., merchants) that may be interested in attracting the user (e.g., as a consumer) to the one or more POIs locations by offering game incentives (e.g., game points, ability to move to an easier level or a challenging level, etc.) based on one or more conditions such as that the user moves in a direction of the one or more POIs (e.g., moving closer), follows a certain path, visits various POIs in certain order, and the like. In one embodiment, the incentives offered is based, at least in part, on proximity of the user to the one or more POI locations that offer the incentives. In various embodiments, the one or more service providers determine and/or offer one or more applications and/or content items suitable for the one or more users, based at least in part, on locations, profiles, preferences, histories, and the like associated with the one or more users, wherein one or more incentives may be offered to the one or more users via the one or more applications and/or content items.

In one embodiment, a relevancy model (e.g., an algorithm) may be utilized to determine relevance of an application and/or a content item, which may be in use by a user, to one or more potential POIs. For example, a user may be playing a sports related electronic game (e.g., tennis, football), when a service provider determines a nearby sporting goods store and presents it as a POI to the user along with one or more incentives for the sports related electronic game (e.g., a better player, better equipment, an easier level, etc.) if the user chooses to travel in the direction of the presented POI. In another example, a user may be playing a car racing game when the service provider determines an auto accessories store as a POI and provides one or more game incentives (e.g., faster cars, easier driving course, etc.) if the user chooses to travel in the direction of the POI. In one embodiment, the service provider may determine relevancy of an application and/or a content item to one or more potential POIs before presenting/offering the application and/or the content item to a user. In one embodiment, a service provider may utilize one or more user and/or device profiles, user preferences, user history, and the like in addition to the relevancy model for determining the one or more applications, content items, and POIs.

In one embodiment, for determining proximity (e.g., including relationship) of a user to a POI (e.g., a vendor), a service provider may utilize a user preference, a user profile, a user history, and the like in addition to a physical distance from the user location to the POI location. For example, user “A” is at 2000 feet from a coffee shop and user “B” is at 3000 feet from the coffee shop, however, user “B” user history (e.g., a VIP status, a local member, has an awards account/card, etc.) indicates prior use of the coffee shop, whereby the service provider may determine a higher level of proximity between the user “B” and the coffee shop when compared to proximity of the user “A” to the coffee shop.

In one embodiment, the system 100 determines a proximity of at least one device to at least one point of interest. In one embodiment, one or more service platforms determine location of one or more devices (e.g., users) and compare to one or more POIs (e.g., in a database) (e.g., a restaurant, a book shop, a coffee shop, etc.) for determining proximity (e.g., distance) of the one or more users to the one or more POIs. For example, global positioning system (GPS) location of a user is compared to one or more POIs nearby.

In one embodiment, the system 100 determines at least one difficulty level associated with at least one application, at least one content item, or a combination thereof based, at least in part, on the proximity. In one embodiment, the one or more service providers determine at least one application (e.g., a game application) and/or at least one content item for presentation to the at least one device, wherein at least one difficulty level (e.g., 1, 2, 3, beginner, expert, easy, etc.) for the at least one application and/or at least one content item is determined based, at least in part, on the proximity of the at least one device to the at least on POI. For example, based on user information associated with the device (e.g., user profile, user history, user preference, etc.) and the device location in reference to a POI (e.g., about 2 miles from a certain coffee shop), at least one game application is provided/presented at the device, wherein the game difficulty level is set to high since the device (e.g., user) is far away. In one embodiment, the one or more service providers determine at least one difficulty level for at least one application and/or at least one content item, which currently may be in use and/or may have been previously utilized at the device.

In one embodiment, the system 100 determines utilization information for the at least one application, the at least one content item, or a combination thereof with respect to at least one user, wherein the at least one difficulty level is further based, at least in part, on the utilization information. In one embodiment, the one or more service providers determine utilization information (e.g., from a user device, from an online game/content provider, etc.) of a user associated with an application and/or a content item, and then the one or more service providers adjust and/or cause an adjustment of the difficulty level of the at least one application and/or content item based on the utilization information. In one embodiment, the one or more service providers determine one or more parameters for adjusting the difficulty level and then make the adjustment. For example, the service provider determines and utilizes the one or more parameters to make the adjustment. In one embodiment, the service provider request that a service provider, a content provider, a content creator, a content owner, or a combination thereof determine the one or more parameters and/or adjust the difficulty level according to a service provider requirement. For example, a service provider may request the one or more parameters from a games developer for making the adjustment. In another example, the service provider may request a content provider to make the adjustment.

In one embodiment, the system 100 processes the utilization information to determine at least one skill level associated with the at least one user, wherein the at least one difficulty level is further based, at least in part, on the at least one skill level. In one embodiment, the one or more service providers determine a user skill (e.g., level 1, expert, beginner, etc.) and history (e.g., from a user device, from online records, from a service provider, etc.) associated with the at least one application and/or content item, and then the one or more service providers adjust the difficulty level of the at least one application and/or content item based on the skill level. For example, a user/player may have previously played (e.g., one or more times) a particular electronic game, wherein the game scores and skill level for the particular electronic game are stored as part of user information on a user device.

In one embodiment, the system 100 causes a recommendation of at least one path to the at least one point of interest to cause, at least in part, an adjustment of the at least one application, the at least one content item, or a combination thereof based, at least in part, on the at least one difficulty level. In one embodiment, the one or more service providers determine locations of one or more users (e.g., devices) and one or more POIs for determining and/or recommending to the one or more users, one or more paths from the one or more user locations to the one or more POIs. Furthermore, the one or more service providers causer one or more adjustments (e.g., utilizing one or more algorithms) to the at least one application and/or the at least one content item based on the at least one difficulty level associated with the at least one application and/or the at least one content item.

In one embodiment, the system 100 determines one or more searches for the at least one point of interest. In one embodiment, the one or more service providers utilize one or more search methods (e.g., search engines, in a database) to search for at least one POI in proximity to the one or more users. For example, there may be two coffee shops, a bakery, and a bank in proximity to a user location (e.g., within a radius of 1 mile).

In one embodiment, the system 100 causes a presentation of the recommendation based, at least in part, on the one or more searches. In one embodiment, the one or more service providers present at a user device (e.g., via a map application) one or more path recommendations based on the one or more searches for the one or more POIs. In various embodiment, the one or more service providers utilize one or more user preferences, user profiles, and the like, in determining, searching, presenting, and/or recommending the one or more paths.

In one embodiment, the system 100 causes a presentation of at least one indicator via a user interface of the at least one device, wherein the at least one indicator depicts, at least in part, a progression of the at least one difficulty level based, at least in part, on the proximity. In one embodiment, the service provider determines and presents via a UI at a device at least one indicator such as a progress bar, a color bar, a color path, and the like, indicative of the at least one difficulty level. For example, a color bar may have a color range from red to green where the red may represent a higher difficulty level and the green may represent a lower difficulty level (e.g., easier level).

In one embodiment, the system 100 causes a presentation of at least one link to the at least one application, the at least one content item, or a combination thereof in the user interface. In one embodiment, one or more links to one or more applications and/or content items are presented at a device via a map application. In one embodiment, one or more links to the one or more POIs are included in the presentation.

In one embodiment, the system 100 determines an input for selecting the at least one link to cause, at least in part, an execution of the at least one application, the at least one content item, or a combination thereof. In one embodiment, a user selection of one or more links (e.g., to one or more applications, content items, POIs, etc.) are detected via a UI at a device (e.g., a user clicks on a link), and one or more applications and/or contents items associated with the one or more selected links are executed and/or retrieved. For example, a game application is started, a content item is opened, an application and/or a content item are retrieved from a content provider, and the like.

In one embodiment, the system 100 causes a restoration of the user interface following completion of the execution. In one embodiment, once one or more executions and/or access to one or more applications and/or content items are completed, the UI at a device restores the UI to present one or more links, one or more suggestions, one or more paths, and the like.

In one embodiment, the system 100 determines that the at least one difficulty level substantially meets a threshold difficulty level based, at least in part, on the proximity. In one embodiment, a difficulty level is based on a distance between a user location and a POI location, wherein the difficulty level may be associated with a particular range of distance and/or the distance may be associated with a particular range of difficulty level. For example, a difficulty level of seven (e.g., in 1-10), may be associated with a distance range of 1-1.5 miles, or a distance of one-half mile is associated with a difficulty range of 3-5, and the like.

In one embodiment, the system 100 causes a presentation of a notification message. In one embodiment, one or more alerts such as a flashing, a vibration, an audio alert, a change of color, and the like, may be utilized in presentation of one or more notification messages associated with a difficulty level and/or a proximity to a POI. For example, an audio alert may indicate a particular difficulty level (e.g., 3). In another embodiment, the notification message is presented at a particular distance (e.g., 1000 feet) from a user location to a POI location.

In one embodiment, the system 100 determines that the at least one application, the at least one content item, or a combination thereof has been at least partially or substantially completed at the at least one level of difficulty. In one embodiment, the one or more service providers receive and/or retrieve user utilization information to determine if the user has partially and/or mostly completed utilization and/or consumption of the one or more applications and/or content items at one or more difficulty levels. For example, it can be determined that a user is utilizing an electronic game application at a difficulty level of three while having completed levels one and two.

In one embodiment, the system 100 causes a presentation of information associated with the at least one point of interest. In one embodiment, the service provider presents on a map application information related to the one or more POIs. For example, a service provider determines (e.g., based on information from a user device, from a content provider, etc.) that a user is playing an electronic game at difficulty level three (e.g., has completed levels one and two) and presents to user (e.g., at the user device) information on one or more POIs (e.g., on a map, as a list, etc.) In one embodiment, the presentation includes a partial presentation of the information based, at least in part, on the proximity. For example, the one or more POIs may be within one-half mile from the user's current location. In one embodiment, the information associated with the one or more POIs includes coupon information, advertisement information, promotional information, or a combination thereof. For example, information associated with a first POI indicates products, service, discount offers, coupons, and the like available via the first POI (e.g., at the first POI location, via an online interaction with the first POI).

In one embodiment, the system 100 determines that at least one device has approached the at least one point of interest to within a threshold proximity. In one embodiment, the one or more service providers determine and/or have information on current locations of one or more devices (e.g., users) and determine one or more distances from the current locations to one or more POIs. For example, a first user is located at 1000 feet from a bookstore, a second user is located at 2000 feet from a sporting goods store, the first and the second users are located at 500 feet from a coffee shop, and the like.

In one embodiment, the system 100 determines at least another difficulty level based, at least in part, on another proximity to at least another point of interest, wherein the at the least another difficulty level is progressively based, at least in part, on the at least one difficulty level. In one example, a user (e.g., a student) is located at a certain proximity (e.g., 2000 feet) to a certain POI (e.g., a book store), is consuming a content item (e.g., reading a chapter in a book) at a certain difficulty level (e.g., level 6 vocabulary and writing style), when a service provider determines and provides to the user an easier version of the chapter (e.g., level 4 with simpler vocabulary and writing style), which is available as a user incentive if the user travels in the direction of the book store, whereby one or more chapters of the book at an easier level (e.g., level 3) may become available to the user if the user continues traveling in the direction of the book store.

In one embodiment, the system 100 causes a monitoring of the proximity continuously, periodically, according to a schedule, on demand, or a combination thereof. In one embodiment, the service provider may monitor proximity of one or more users to one or more POIs based on one or more requests, schedules, predetermined trigger conditions (e.g., within a certain distance), and the like provided by the one or more users, the one or more POIs (e.g., merchants), and/or by one or more other service providers.

In one embodiment, the system 100 causes an updating of the at least one difficulty level based, at least in part, on the monitoring. In one embodiment, one or more difficulty levels associated with one or more applications and/or content items are updated based on the monitoring of the proximity of the one or more users to the one or more POIs.

As shown in FIG. 1, in one embodiment, the system 100 includes user equipment (UE) 101a-101n (also collectively referred to as UE 101), which may be utilized to execute one or more applications 103a-103n (also collectively referred to as applications 103) (e.g., games, social networking, a web browser, a media application, user interface, GPS, a map application, a web client, etc.) to communicate with other UEs 101, a processing platform 105, a services platform 107, an application/content (A/C) provider 109, GPS satellite 117, and/or with other components of a communication network directly and/or over a communication network 111. In one embodiment, the services platform 107 may include one or more services 113a-113k (also collectively referred to as services 113), which may provide one or more services (e.g., online gaming, online content, online shopping, etc.)

The UE 101 is any type of mobile terminal, fixed terminal, or portable terminal including a mobile handset, station, unit, device, multimedia computer, multimedia tablet, Internet node, communicator, desktop computer, laptop computer, notebook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.)

In one embodiment, the UE 101 includes a location module/sensor that can determine the UE 101 location (e.g., a user's location). The UE 101 location can be determined by a triangulation system such as a global positioning system (GPS), assisted GPS (A-GPS), Cell of Origin, wireless local area network triangulation, or other location extrapolation technologies. Standard GPS and A-GPS systems can use satellites 117 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module/sensor may also utilize multiple technologies to detect the location of the UE 101. GPS coordinates can provide finer detail as to the location of the UE 101. In another embodiment, the UE 101 may utilize a local area network (e.g., WLAN) connection to determine the UE 101 location information, for example, from an Internet source (e.g., a service provider).

In one embodiment, the A/C provider 109 may provide one or more applications and/or contents (e.g., related to electronic games, media, maps, educational, etc.), which may be for free and/or for a fee and may be available to the UE 101, the processing platform 105, the services platform 107, the services 113, and/or to other entities of the system 100. For example, the A/C provider may provide various electronic game applications (e.g., puzzles, educational, multiplayer, single player, etc.), wherein one or more users may utilize one or more game applications to play online and/or download to a user device. Further, the A/C provider 109 may provide the applications and/or the contents to one or more entities of the system 100 for further distribution. For example, the services platform 107 (e.g., one or more services 113) may request/receive the one or more applications and/or contents from the A/C provider 109 and provide them to one or more users, customers, clients, vendors, other one or more service providers, and the like, for a fee, for free, for promotional and marketing, as user/customer incentives, and the like. In one embodiment, the A/C provider 109 may receive one or more applications and/or contents from one or more users, the processing platform 105, the services platform 107, the services 113, and/or to other entities of the system 100.

In one embodiment, the processing platform 105 may receive one or more requests from one or more users, the services platform 107, the A/C provider 109, and/or one or more other entities of the system 100, wherein the request may be for processing one or more applications, contents, requests (e.g., requests from one or more users to the services platform 107, which are then sent to the processing platform 105), coupons, incentives, and the like. In one embodiment, the processing platform 105 may receive one or more requests to monitor, process, determine, modify, and/or adjust one or more parameters associated with utilization and/or availability of the one or more applications and/or contents. In one scenario, a user may wish to utilize an application and/or consume a content at/via the A/C provider 109 and/or the services platform 107, wherein the A/C provider 109 and/or the services platform 107 request to adjust (e.g., dynamically) one or more parameters of the application and/or the content before and/or while the application and/or the content is being utilized/consumed. Further, the processing platform 105 may process the request, determine one or more parameters (e.g., a game level, game points, content consumption difficulty, etc.) required to make the requested adjustment, and cause the adjustment via the processing platform 105, via the services platform 107, via the A/C provider 109, or a combination thereof. For example, a user is playing a game at/via the services platform 107 and the services platform 107 requests to provide (e.g., real-time, via the game application) one or more incentives such as game points, access to different levels of the game, a coupon associated with one or more POIs (e.g., a merchant), wherein the processing platform 105 processes the request and causes transmission of the one or more incentives to the user. In certain embodiments, the processing platform 105 is implemented as a collection of one or more hardware, software, algorithms, firmware, or combinations thereof that can be integrated for use with the services platform 107 and/or with the A/C provider 109. In various embodiments, the processing platform 105 may be a separate entity in the system 100 and/or may be maintained on a network server, while operating in connection with the services platform 107 and/or with the A/C provider 109 as an extensible feature, a web-service, an applet, a script, an object-oriented application, included within the UE 101 (e.g., as part of the applications 103), or a combination thereof. Further, the processing platform 105, the services platform 107, and/or the A/C provider 109 may utilize one or more service application programming interfaces (APIs)/integrated interface, through which communication, media, content, and information may be shared, accessed and/or processed.

In one embodiment, the services platform 107 may include one or more service providers (e.g., services 113) offering one or more services, for example, online shopping, online gaming, social networking services (e.g., blogging), media upload, media download, media streaming, account management services, or a combination thereof. Further, the services platform 107 may facilitate interactions between the processing platform 105, the A/C provider 109, the services 113, and/or other entities of the system 100. For example, the services platform 107 may request for the A/C provider 109 to provide one or more applications and/or contents to the processing platform 105 for analysis/processing and for utilization by the services 113 in providing one or more services to one or more users and/or one or more entities of the system 100.

In one embodiment, the processing platform 105, the services platform 107, and/or the A/C provider 109 may interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

By way of example, the communication network 111 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

By way of example, the UEs 101, the processing platform 105, the services platform 107, and the A/C provider 109 communicate with each other and other components of the communication network 111 using well known, new or still developing protocols. In this context, a protocol includes a set of rules defining how the network nodes within the communication network 111 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model. Further, one or more components of the system 100 may directly and/or indirectly communicate with one or more other components of the system 100 via the communication network 111 and/or via other communication channels.

Further, the communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

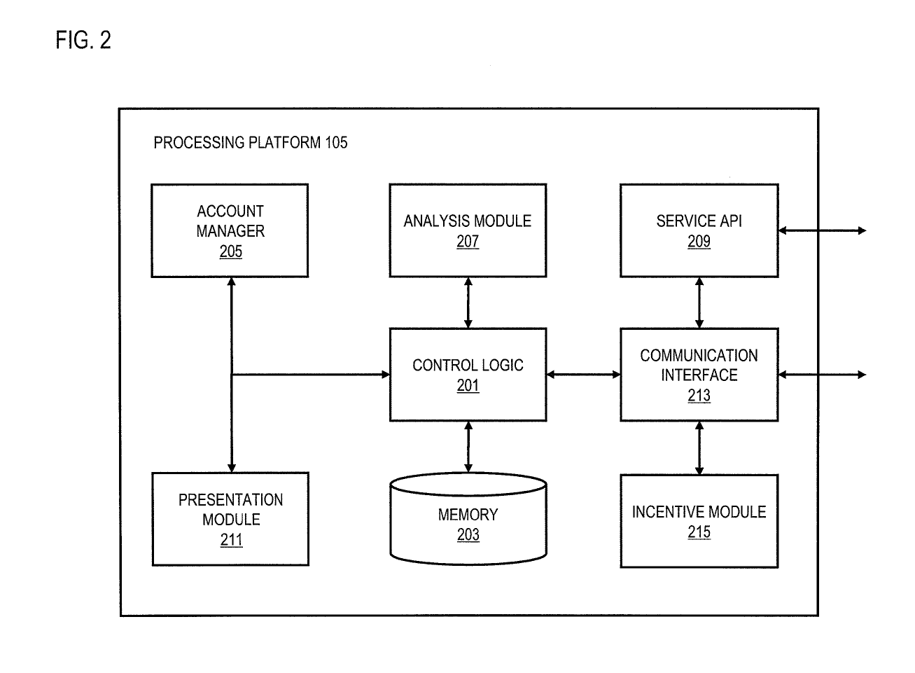

FIG. 2 is a diagram of the components of a processing platform, according to one embodiment. By way of example, the processing platform 105 includes one or more components for analyzing and processing one or more applications, one or more contents, one or more information items, one or more requests, or a combination thereof from one or more users, the services platform 107, the A/C provider 109, one or more other entities of the system 100, or a combination thereof. It is contemplated that the functions of these components may be combined in one or more components or performed by other components of equivalent functionality. In this embodiment, the processing platform 105 includes a control logic (or processor) 201, memory 203, an account manager 205, an analysis module 207, a service API 209, a presentation module 211, a communication interface 213, and an incentive module 215.

The control logic 201 executes at least one algorithm, software, application, and the like for executing functions of the processing platform 105. For example, the control logic 201 may interact with the account manager 205 to receive one or more requests to register one or more users, one or more service providers, one or more content providers, one or more applications, one or more content items, or a combination thereof.

As such, the account manager 205 may work with the analysis module 207, via the control logic 201, to process the user and product information to generate a user profile and/or add new product information to an account already associated with the user. As discussed, the media, content and information associated with the product and/or the user may be captured (e.g., via a sound recorder, a camera, a camcorder, etc.) or retrieved from a local or remote database (e.g., a search database, a social networking database, etc.), a content provider, a user device, another service provider, and the like.

Next, the control logic 201 may then direct the service API 209 to utilize one or more parameters for dynamically adjusting and/or causing adjustment of the one or more applications and/or content items at a user device. Further, the service API 209 may provide the one or more parameters to one or more service providers, application developers, content providers, content creators, content owners, and the like so that the one or more dynamic adjustments can be made.

The presentation module 211 may be utilized to present one or more information items, notifications, incentives, updates, and the like to one or more users and/or one or more service providers. For example, an electronic coupon may be processed and presented by the presentation module such that it may contain information associated with a POI, a product, a service, a user defined notification, and the like.

The control logic 201 may also utilize the communication interface 213 to communicate with other components of the processing platform 105, the UEs 101, the services platform 107, the A/C provider 109, and other components of the system 100. For example, the communication interface 213 may transmit a notification to a user's device to indicate availability of one or more user incentives from one or more POIs. The communication interface 213 may further include multiple means of communication. In one use case, the communication interface 213 may be able to communicate over SMS, internet protocol, instant messaging, voice sessions (e.g., via a phone network), or other types of communication.

Furthermore, the incentive module 215 may include one or more incentives available from one or more POIs (e.g., merchants), wherein the one or more incentives may be categorized, listed, grouped, parsed, and the like according to one or more parameters and/or rules set by the one or more POIs and/or by one or more service providers. Additionally, the one or more incentives may be continuously available and/or may be updated by the one or more POIs and/or one or more service providers.

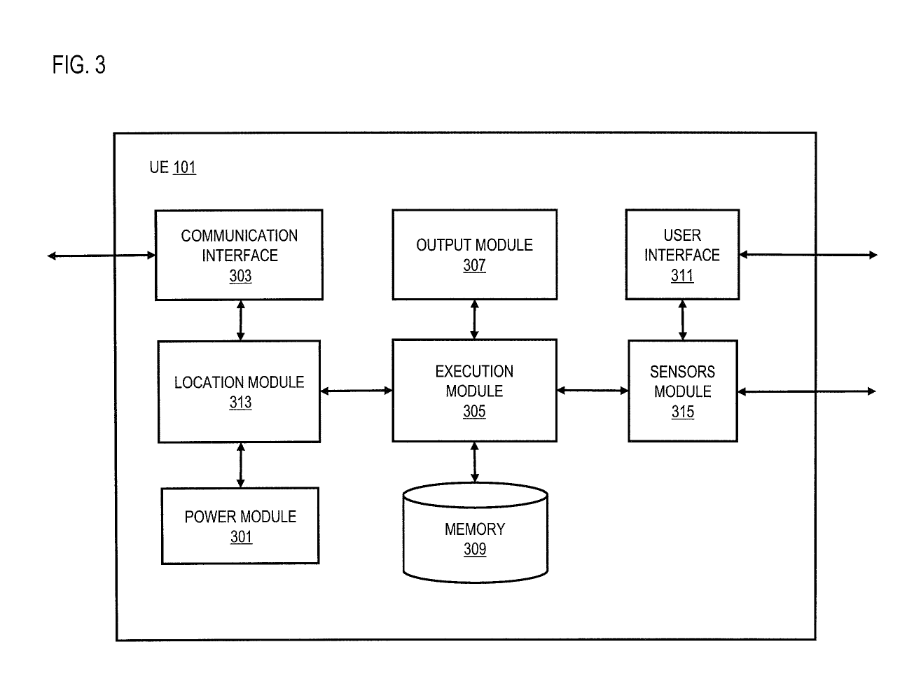

FIG. 3 is a diagram of the components of a user equipment, according to an embodiment. It is contemplated that the functions of these components may be combined in one or more components or performed by other components of equivalent functionality. In this example embodiment, the UE 101 includes a power module 301 to provide power and power control to the UE 101, a communication interface 303 to communicate over a network, an execution module 305 to control the runtime of applications executing on the UE 101, an output module 307, a memory 309, a user interface 311, a location module 313 for determining a location of the UE 101, and sensors module 315 which includes various sensors such as accelerometers, gyroscopes, compass, motion sensors, and the like.

In one embodiment, the UE 101 includes a power module 301. The power module 301 provides power to the UE 101. The power module 301 can include any type of power source (e.g., battery, plug-in, etc.). Additionally, the power module 301 can provide power to the components of the UE 101 including processors, memory 309, and transmitters.

In one embodiment, the communication interface 303 may include multiple means of communication. For example, the communication interface 303 may be able to communicate over SMS, internet protocol, instant messaging, voice sessions (e.g., via a phone network), or other types of communication. The communication interface 303 can be used by the execution module 305 to communicate with other UEs 101, the processing platform 105, the services platform 107 and/or with the A/C provider 109.

In one embodiment, a UE 101 includes a user interface 311. The user interface 311 can include various methods of communication. For example, the user interface 311 can have outputs including a visual component (e.g., a screen), an audio component, a physical component (e.g., vibrations), and other methods of communication. User inputs can include a touch-screen interface, a scroll-and-click interface, a button interface, etc. In certain embodiments, the user interface 311 may additionally have a vocal user interface component. As such, a text-to-speech mechanism may be utilized to provide textual information to the user. Further, a speech-to-text mechanism may be utilized to receive vocal input and convert the vocal input into textual input. Moreover, the user interface 311 may be utilized to present status information as to the status of a resource and/or resource availability information.

In one embodiment, the output module 307 facilitates a creation and/or a modification of at least one device user interface element, at least one device user interface functionality, or a combination thereof based, at least in part, on information, data, messages, and/or signals resulting from any of the processes and or functions of the service platform 103 and/or any of its components or modules. By way of example, a device user interface element can be a display window, a prompt, an icon, and/or any other discrete part of the user interface presented at, for instance, the UE 101. In addition, device user interface functionality refers to any process, action, task, routine, etc. that supports or is triggered by one or more of the user interface elements. For example, user interface functionality may enable speech to text recognition, haptic feedback, and the like. Moreover, it is contemplated that the output module 307 can operate based at least in part on processes, steps, functions, actions, etc. taken locally (e.g., local with respect to a UE 101) or remotely (e.g., over another component of the communication network 111 or other means of connectivity).

In one embodiment, the location module 315 can determine a user's location. The user's location can be determined by a triangulation system such as a global positioning system (GPS), assisted GPS (A-GPS), Cell of Origin, wireless local area network triangulation, or other location extrapolation technologies. Standard GPS and A-GPS systems can use one or more satellites 117 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 315 may also utilize multiple technologies to detect the location of the UE 101. The GPS coordinates can provide finer detail as to the location of the UE 101. As previously noted, the location module 315 may be utilized to determine location coordinates for use by the application 103. In an example embodiment, the UE 101 may utilize a local area network (e.g., WLAN) connection to determine the UE 101 location information, for example, from an Internet source (e.g., a service provider).

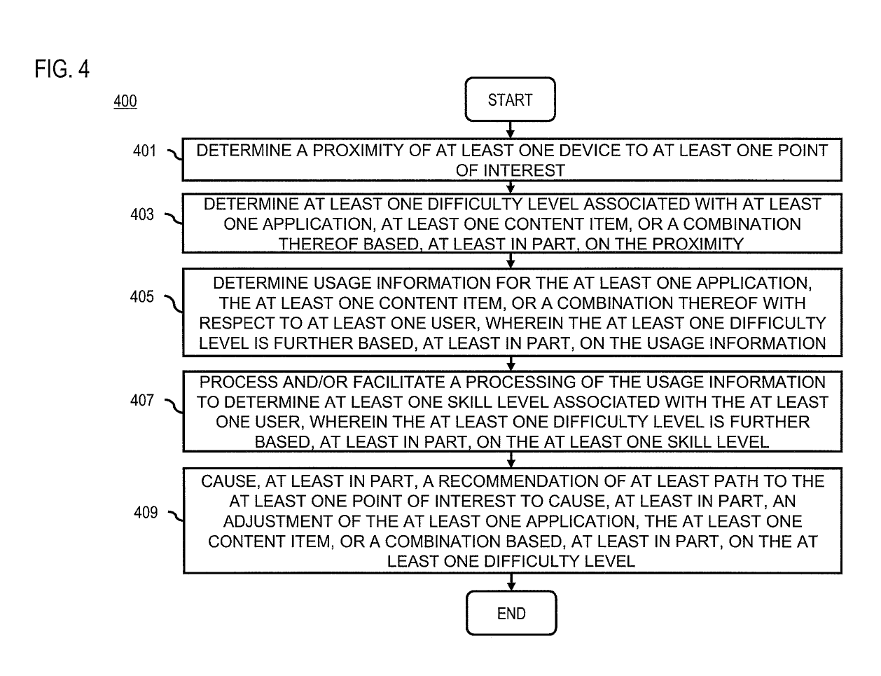

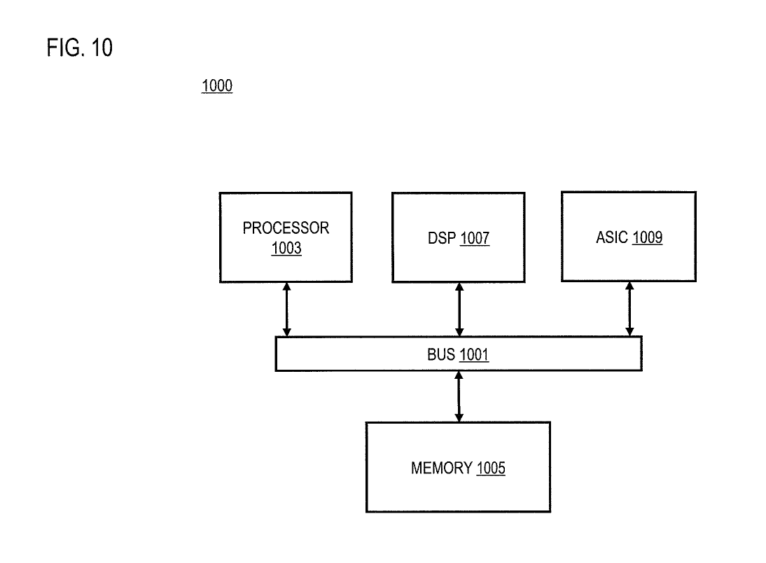

FIG. 4 is a flowchart of a process for determining location information and difficulty level, according to an embodiment. In one embodiment, the processing platform 105 and/or the services platform 107 performs the process 400 and is implemented in, for instance, a chip set including a processor and a memory as shown in FIG. 10. In one embodiment, the control logic 201 can provide means for accomplishing various parts of the process 400 as well as means for accomplishing other processes in conjunction with other components of the processing platform 105.

In step 401, the processing platform 105 and/or the services platform 107 determines a proximity of at least one device to at least one point of interest. In one embodiment, one or more service providers determine location of one or more devices (e.g., users) and compare to one or more POIs (e.g., in a database) (e.g., a restaurant, a book shop, a coffee shop, etc.) for determining proximity (e.g., distance) of the one or more users to the one or more POIs. For example, global positioning system (GPS) location of a user is compared to one or more POIs nearby.

In step 403, the processing platform 105 and/or the services platform 107 determines at least one difficulty level associated with at least one application, at least one content item, or a combination thereof based, at least in part, on the proximity. In one embodiment, the one or more service providers determine at least one application (e.g., a game application) and/or at least one content item for presentation to the at least one device, wherein at least one difficulty level (e.g., 1, 2, 3, beginner, expert, easy, etc.) for the at least one application and/or at least one content item is determined based, at least in part, on the proximity of the at least one device to the at least on POI. For example, based on user information associated with the device (e.g., user profile, user history, user preference, etc.) and the device location in reference to a POI (e.g., about 2 miles from a certain coffee shop), at least one game application is provided/presented at the device, wherein the game difficulty level is set to high since the device (e.g., user) is far away. In one embodiment, the one or more service providers determine at least one difficulty level for at least one application and/or at least one content item, which currently may be in use and/or may have been previously utilized at the device.

In step 405, the processing platform and/or the services platform 107 determines utilization information for the at least one application, the at least one content item, or a combination thereof with respect to at least one user, wherein the at least one difficulty level is further based, at least in part, on the utilization information. In one embodiment, the one or more service providers determine utilization information (e.g., from a user device, from an online game/content provider, etc.) of a user associated with an application and/or a content item, and then the one or more service providers adjust and/or cause an adjustment of the difficulty level of the at least one application and/or content item based on the utilization information. In one embodiment, the one or more service providers determine one or more parameters for adjusting the difficulty level and then make the adjustment. For example, the service provider determines and utilizes the one or more parameters to make the adjustment. In one embodiment, the service provider request that a service provider, a content provider, a content creator, a content owner, or a combination thereof determine the one or more parameters and/or adjust the difficulty level according to a service provider requirement. For example, a service provider may request the one or more parameters from a games developer for making the adjustment. In another example, the service provider may request a content provider to make the adjustment.

In step 407, the processing platform 105 and/or the services platform 107 processes and/or facilitates a processing of the utilization information to determine at least one skill level associated with the at least one user, wherein the at least one difficulty level is further based, at least in part, on the at least one skill level. In one embodiment, the one or more service providers determine a user skill (e.g., level 1, expert, beginner, etc.) and history (e.g., from a user device, from online records, from a service provider, etc.) associated with the at least one application and/or content item, and then the one or more service providers adjust the difficulty level of the at least one application and/or content item based on the skill level. For example, a user/player may have previously played (e.g., one or more times) a particular electronic game, wherein the game scores and skill level for the particular electronic game are stored as part of user information on a user device.

In step 409, the processing platform 105 and/or the services platform 107 causes, at least in part, a recommendation of at least path to the at least one point of interest to cause, at least in part, an adjustment of the at least one application, the at least one content item, or a combination thereof based, at least in part, on the at least one difficulty level. In one embodiment, the one or more service providers determine locations of one or more users (e.g., devices) and one or more POIs for determining and/or recommending to the one or more users, one or more paths from the one or more user locations to the one or more POIs. Furthermore, the one or more service providers causer one or more adjustments (e.g., utilizing one or more algorithms) to the at least one application and/or the at least one content item based on the at least one difficulty level associated with the at least one application and/or the at least one content item.

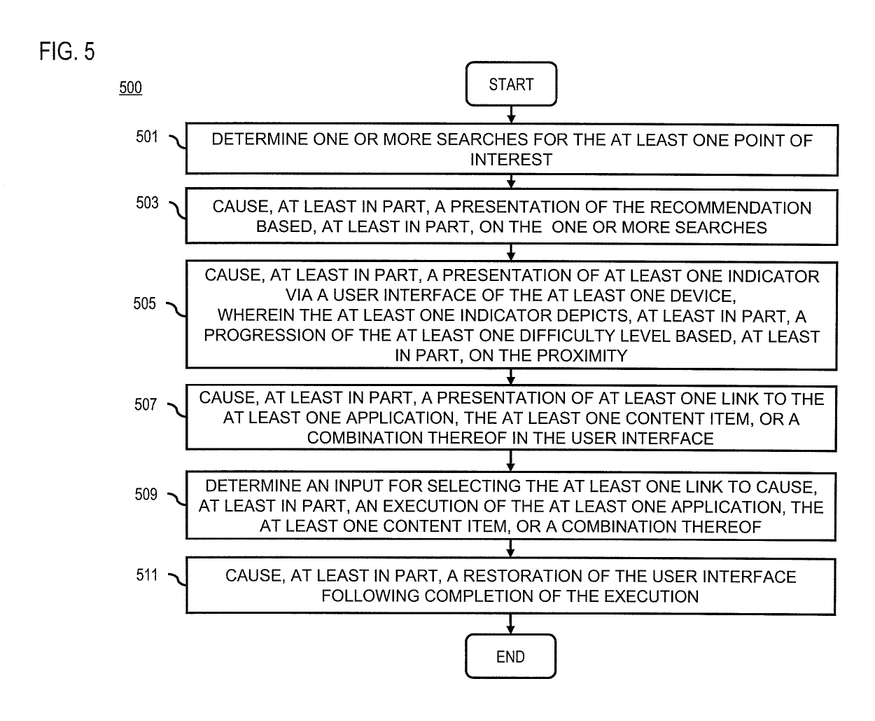

FIG. 5 is a flowchart of a process for searching for a point of interest and presenting a recommendation, according to an embodiment. In one embodiment, the processing platform 105 and/or the services platform 107 performs the process 500 and is implemented in, for instance, a chip set including a processor and a memory as shown in FIG. 10. In one embodiment, the control logic 201 can provide means for accomplishing various parts of the process 500 as well as means for accomplishing other processes in conjunction with other components of the processing platform 105.

In step 501, the processing platform 105 and/or the services platform 107 determine one or more searches for the at least one point of interest. In one embodiment, the one or more service providers utilize one or more search methods (e.g., search engines, in a database) to search for at least one POI in proximity to the one or more users. For example, there may be two coffee shops, a bakery, and a bank in proximity to a user location (e.g., within a radius of 1 mile).

In step 503, the processing platform 105 and/or the services platform 107 cause, at least in part, a presentation of the recommendation based, at least in part, on the one or more searches. In one embodiment, the one or more service providers present at a user device (e.g., via a map application) one or more path recommendations based on the one or more searches for the one or more POIs. In various embodiments, the one or more service providers utilize one or more user preferences, user profiles, and the like, in determining, searching, presenting, and/or recommending the one or more paths.

In step 505, the processing platform 105 and/or the services platform 107 cause, at least in part, a presentation of at least one indicator via a user interface of the at least one device, wherein the at least one indicator depicts, at least in part, a progression of the at least one difficulty level based, at least in part, on the proximity. In one embodiment, the service provider determines and presents via a UI at a device at least one indicator such as a progress bar, a color bar, a color path, and the like, indicative of the at least one difficulty level. For example, a color bar may have a color range from red to green where the red may represent a higher difficulty level and the green may represent a lower difficulty level (e.g., easier level).

In step 507, the processing platform 105 and/or the services platform 107 cause, at least in part, a presentation of at least one link to the at least one application, the at least one content item, or a combination thereof in the user interface. In one embodiment, one or more links to one or more applications and/or content items are presented at a device via a map application. In one embodiment, one or more links to the one or more POIs are included in the presentation.

In step 509, the processing platform 105 and/or the services platform 107 determine an input for selecting the at least one link to cause, at least in part, an execution of the at least one application, the at least one content item, or a combination thereof. In one embodiment, a user selection of one or more links (e.g., to one or more applications, content items, POIs, etc.) are detected via a UI at a device (e.g., a user clicks on a link), and one or more applications and/or contents items associated with the one or more selected links are executed and/or retrieved. For example, a game application is started, a content item is opened, an application and/or a content item are retrieved from a content provider, and the like.

In step 511, the processing platform 105 and/or the services platform 107 cause, at least in part, a restoration of the user interface following completion of the execution. In one embodiment, once one or more executions and/or access to one or more applications and/or content items are completed, the UI at a device restores the UI to present one or more links, one or more suggestions, one or more paths, and the like.

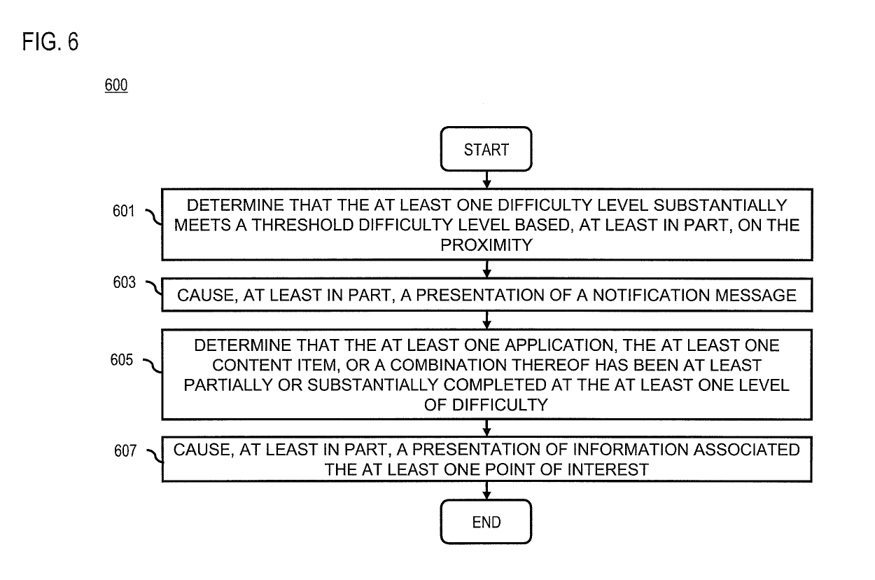

FIG. 6 is a flowchart of a process for determining a difficult level based on one or more parameters, according to an embodiment. In one embodiment, the processing platform 105 and/or the services platform 107 perform the process 600 and are implemented in, for instance, a chip set including a processor and a memory as shown in FIG. 10. In one embodiment, the control logic 201 can provide means for accomplishing various parts of the process 600 as well as means for accomplishing other processes in conjunction with other components of the processing platform 105.

In step 601, the processing platform 105 and/or the services platform 107 determine that the at least one difficulty level substantially meets a threshold difficulty level based, at least in part, on the proximity. In one embodiment, a difficulty level is based on a distance between a user location and a POI location, wherein the difficulty level may be associated with a particular range of distance and/or the distance may be associated with a particular range of difficulty level. For example, a difficulty level of seven (e.g., in 1-10), may be associated with a distance range of 1-1.5 miles, or a distance of one-half mile is associated with a difficulty range of 3-5, and the like.

In step 603, the processing platform 105 and/or the services platform 107 cause, at least in part, a presentation of a notification message. In one embodiment, one or more alerts such as a flashing, a vibration, an audio alert, a change of color, and the like, may be utilized in presentation of one or more notification messages associated with a difficulty level and/or a proximity to a POI. For example, an audio alert may indicate a particular difficulty level (e.g., 3). In another embodiment, the notification message is presented at a particular distance (e.g., 1000 feet) from a user location to a POI location.

In step 605, the processing platform 105 and/or the services platform 107 determine that the at least one application, the at least one content item, or a combination thereof has been at least partially or substantially completed at the at least one level of difficulty. In one embodiment, the one or more service providers receive and/or retrieve user utilization information to determine if the user has partially and/or mostly completed utilization and/or consumption of the one or more applications and/or content items at one or more difficulty levels. For example, it can be determined that a user is utilizing an electronic game application at a difficulty level of three while having completed levels one and two.

In step 607, the processing platform 105 and/or the services platform 107 cause, at least in part, a presentation of information associated with the at least one point of interest. In one embodiment, the one or more service providers present on a map application information related to the one or more POIs. For example, a service provider determines (e.g., based on information from a user device, from a content provider, etc.) that a user is playing an electronic game at difficulty level three (e.g., has completed levels one and two) and presents to user (e.g., at the user device) information on one or more POIs (e.g., on a map, as a list, etc.) In one embodiment, the presentation includes, at least in part, a partial presentation of the information based, at least in part, on the proximity. For example, the one or more POIs may be within one-half mile from the user's current location. In one embodiment, the information associated with the one or more POIs includes, at least in part, coupon information, advertisement information, promotional information, or a combination thereof. For example, information associated with a first POI indicates products, service, discount offers, coupons, and the like available via the first POI (e.g., at the first POI location, via an online interaction with the first POI).

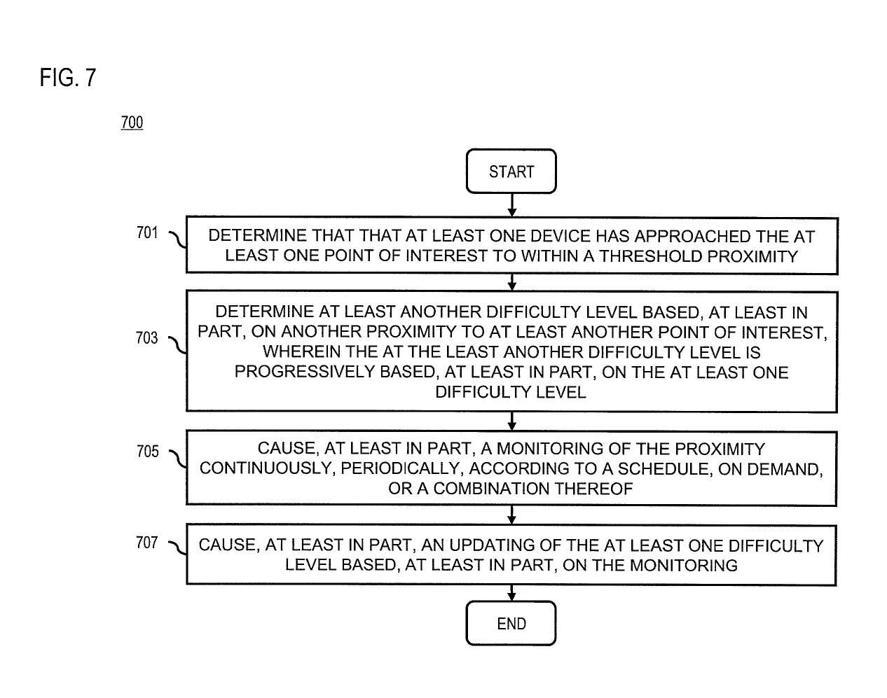

FIG. 7 is a flowchart of a process for determining proximity of a user to a point of interest adjusting a difficulty level accordingly, according to an embodiment. In one embodiment, the processing platform 105 and/or the services platform 107 perform the process 700 and are implemented in, for instance, a chip set including a processor and a memory as shown in FIG. 10. In one embodiment, the control logic 201 can provide means for accomplishing various parts of the process 700 as well as means for accomplishing other processes in conjunction with other components of the processing platform 105.

In step 701, the processing platform 105 and/or the services platform 107 determine that that at least one device has approached the at least one point of interest to within a threshold proximity. In one embodiment, the one or more service providers determine and/or have information on current locations of one or more devices (e.g., users) and determine one or more distances from the current locations to one or more POIs. For example, a first user is located at 1000 feet from a bookstore, a second user is located at 2000 feet from a sporting goods store, the first and the second users are located at 500 feet from a coffee shop, and the like.

In step 703, the processing platform 105 and/or the services platform 107 determine at least another difficulty level based, at least in part, on another proximity to at least another point of interest, wherein the at the least another difficulty level is progressively based, at least in part, on the at least one difficulty level. In one example, a user (e.g., a student) is located at a certain proximity (e.g., 2000 feet) to a certain POI (e.g., a book store), is consuming a content item (e.g., reading a chapter in a book) at a certain difficulty level (e.g., level 6 vocabulary and writing style), when a service provider determines and provides to the user an easier version of the chapter (e.g., level 4 with simpler vocabulary and writing style), which is available as a user incentive if the user travels in the direction of the book store, whereby one or more chapters of the book at an easier level (e.g., level 3) may become available to the user if the user continues traveling in the direction of the book store.

10095) In step 705, the processing platform 105 and/or the services platform 107 cause, at least in part, a monitoring of the proximity continuously, periodically, according to a schedule, on demand, or a combination thereof. In one embodiment, the one or more service providers may monitor proximity of one or more users to one or more POIs based on one or more requests, schedules, predetermined trigger conditions (e.g., within a certain distance), and the like provided by the one or more users, the one or more POIs (e.g., merchants), and/or by one or more other service providers.

In step 707, the processing platform 105 and/or the services platform 107 cause, at least in part, an updating of the at least one difficulty level based, at least in part, on the monitoring. In one embodiment, one or more difficulty levels associated with one or more applications and/or content items are updated based on the monitoring of the proximity of the one or more users to the one or more POIs.

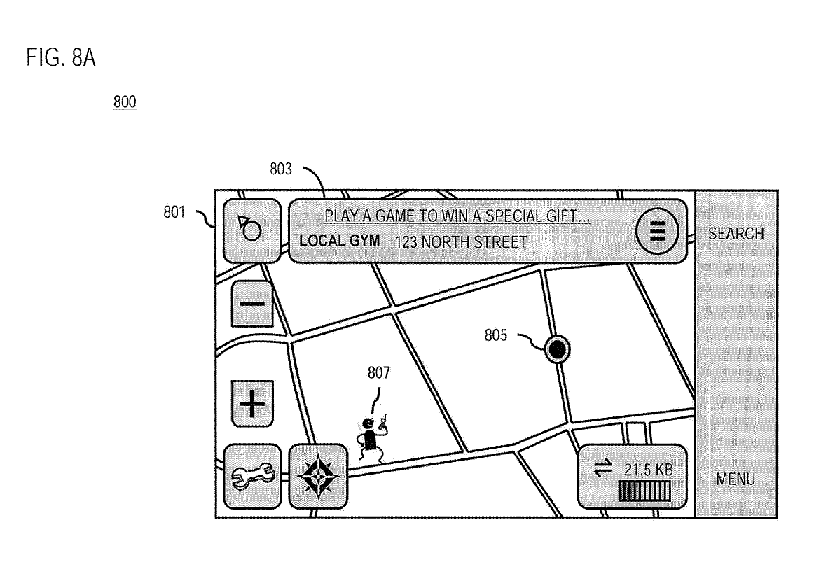

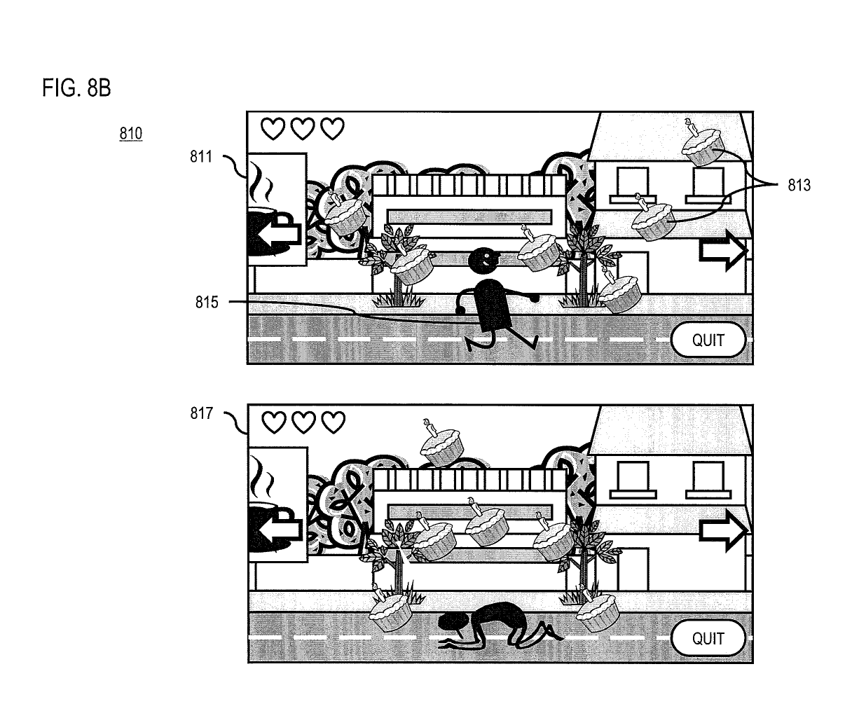

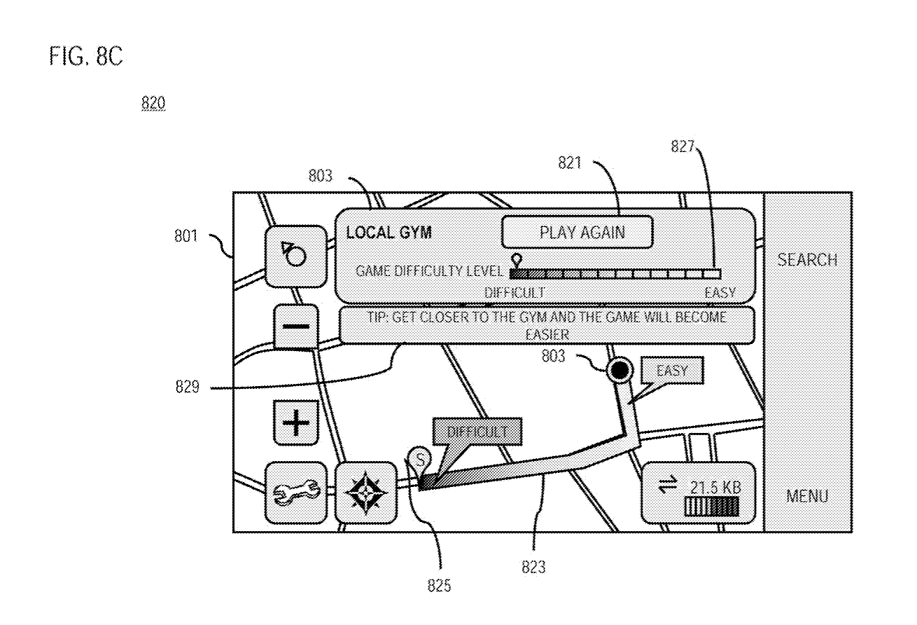

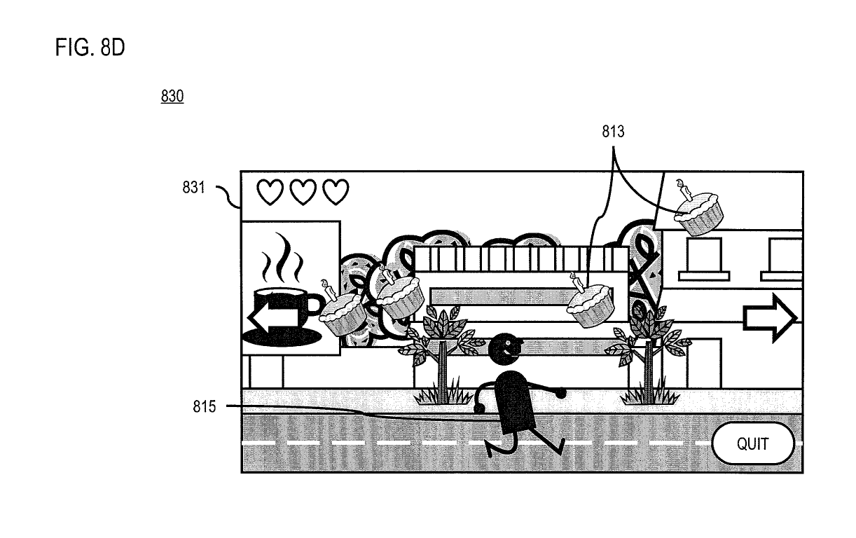

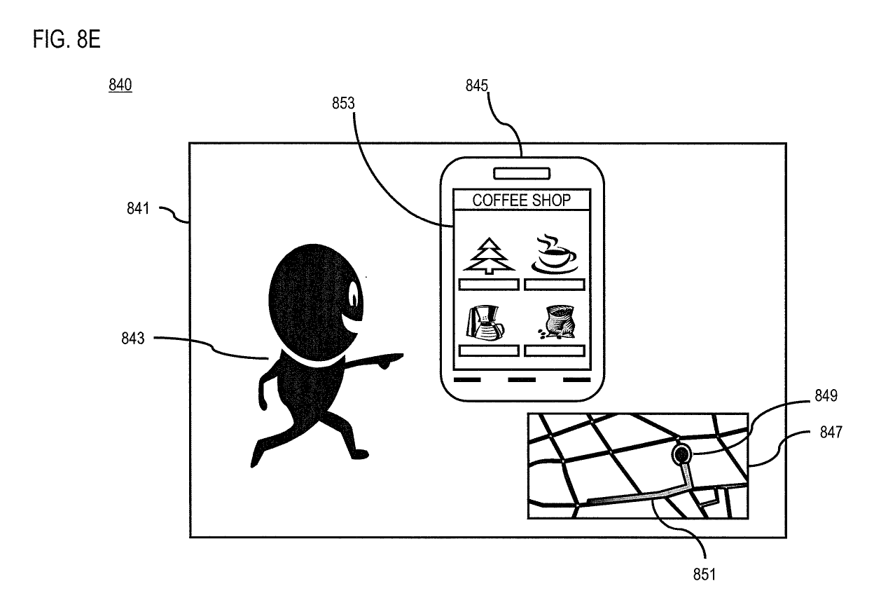

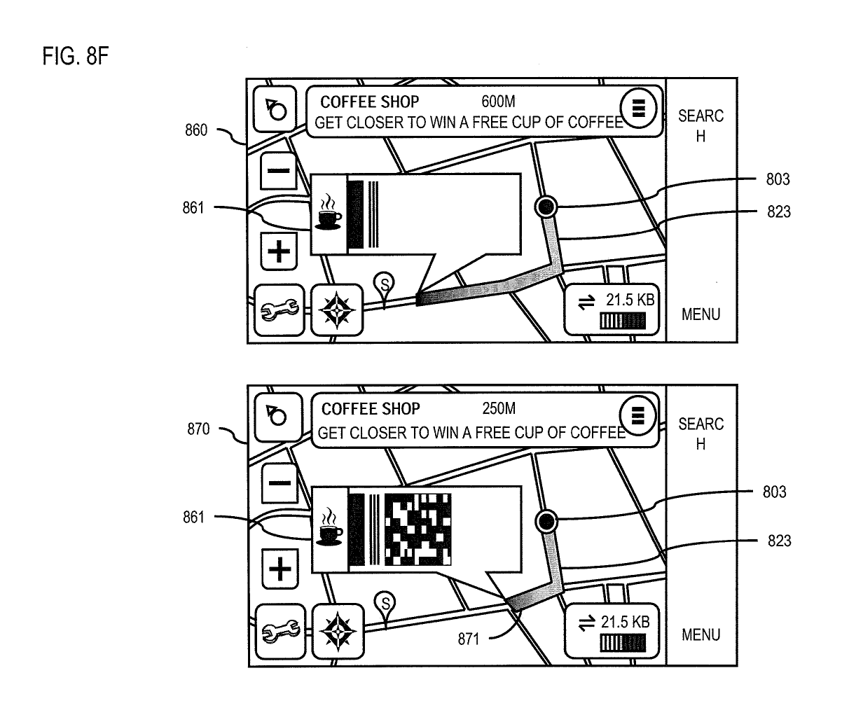

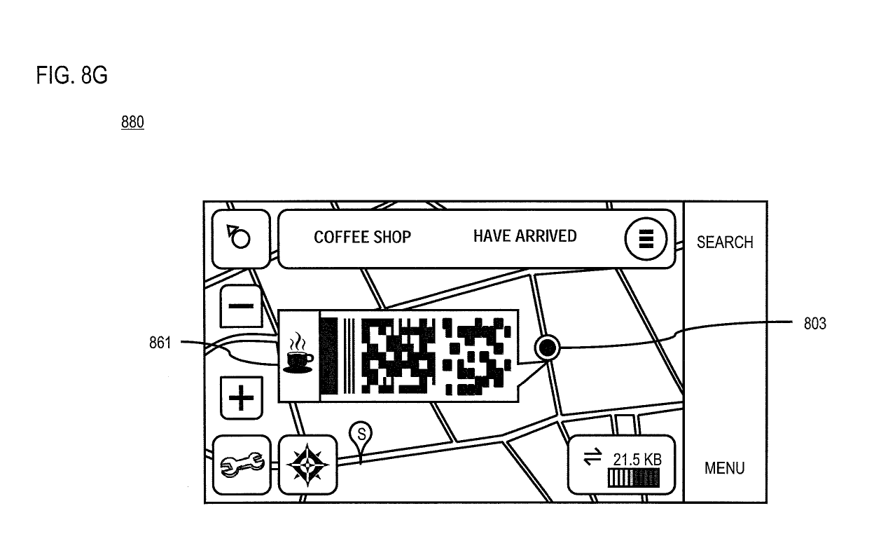

FIGS. 8A-8G are diagrams and user interfaces utilized in the processes of FIGS. 4-7, according to various embodiments.

FIG. 8A features UI 800 showing a map application 801 utilized by a service provider to provide information 803 and location indicator 805 associated with a POI (e.g., a service provider, a merchant, etc.) “Local Gym” and location indicator 807 associated with a device/user. In various embodiments, the information 803 may be associated with one or more POIs, promotions, offers, discounts, and the like, wherein location indicator 805 and/or other location indicators may be associated with one or more POIs (e.g., a group of POIs). In one example, location information of the device 807 is utilized to determine the information 803 and the location 805 associated with the POI “Local Gym,” wherein an offer (e.g., a link) to play a free electronic game (e.g., online, on the device, etc.) to win a special gift is presented to the user 807. In various embodiments, the service provider may utilize one or more user information such as a user profile, user preferences, user history, and the like to determine and/or match one or more POIs (e.g., offers) with the user.

FIG. 8B illustrates an example electronic game application 810 with UIs 811 and 817 presented to the user 807, wherein cakes 813 are falling (e.g., raining cakes) and an objective may be to run a character 815 through streets while avoiding the cakes 813. The UT 817 depicts an example where there may be too many falling cakes and/or the character 815 may not be able to run quickly enough to avoid the cakes (e.g., difficult level), hits the cakes, and loses the game.

FIG. 8C illustrates UI 820 utilized in providing additional information included with the information 803. In one embodiment, the information 803 includes an option 821 to replay (e.g., “Play Again”) the 810 game, a path representation 823 with a start point 825 (e.g., from the user 807 location) and an end point at the POI 805 location. In various embodiments, the path 823 may be determined based on user information, user preferences, user profile, user history, information of one or more entities (e.g., a merchant association) associated with the POI, and the like. Further, indicator 827 shows difficulty level information (e.g., 1-10, easy, difficult, color range, etc.) associated with the electronic game application 810, wherein the difficulty level information 827 (e.g., difficult, easy, color range, etc.) may also be transposed onto the path representation 823. For example, a color range displayed on the indicator 827 is reflected on the path 823 so that the user 807 may visually see the difficulty level along a path he may choose to travel on. Further, a message 829 indicative of one or more tips, hints, clues, and the like may be presented to the user, for example, to provide a tip to the user that “get closer to the gym and the game will become easier.” In one embodiment, the user 807 may decide to travel on the path 823, but begin playing the game 810 only when his proximity to the POI 805 is at a certain distance and/or only when the difficulty level is at a certain level (e.g., easier, more challenging), which may be what the user 807 is interested in.

FIG. 8D illustrates example 830 of the electronic game showing UI 831 where the game level is easier, for example, there are less falling cakes 813, wherein the character 815 may run faster/longer with a less chance of an accident with the falling cakes 813.

FIG. 8E illustrates an example of an electronic game 840 and a UI 841. In one example, a user 843 is playing the electronic game 840 (e.g., a running game) on device 845, wherein the user 843 has tried several times, but has not successfully complete the game. Further, the user 843 utilized a map application 847 to view and choose a POI 849 (e.g., a coffee shop) and a path 851 for travelling to the POI 849. Furthermore, as the user 843 gets closer to the POI 849, he collects extra health points, is able to run faster than normal, and successfully completes the game 840 when he is still 200 meters away from the POI 849 (the coffee shop). Initially, the user 843 had decided to return to his original location, but a notifying message on the device 845 (e.g., from a service provider) presents one or more discount/coupon offers 853 available at the POI 849, which the user 843 decides to visit and enquire about offers 853 since he is near the POI (e.g., 200 meters away).

FIG. 8F illustrates UIs 860 and 870 showing various information items associated with an application, a user, a POI and information associated with the POI. In UI 860, as a user travels on the path 823 and is closer (e.g., 600 meters) to the POI 805, a service provider presents an offer 861 (e.g., an electronic bar code for a coupon) available at the POI 805 (e.g., the coffee shop), wherein the offer 861 only shows a partial view of the offer 861 (e.g., rest of the offer is blurred, not shown, etc.) Further, the UI 870 shows that the user has continued to travel closer to the POI 805 and is now at a point 871 (e.g., 250 meters), wherein additional information (e.g., additional parts) of the offer 861 are now displayed. In one embodiment, the user may travel along one or more paths for reaching the POI 805. FIG. 8G shows UI 880 indicating that the user has arrived at the POI 805, wherein the offer 861 includes complete offer information.

The processes described herein for determining proximity of a user to a POI to dynamically adapt applications, content, and user incentive may be advantageously implemented via software, hardware, firmware, or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

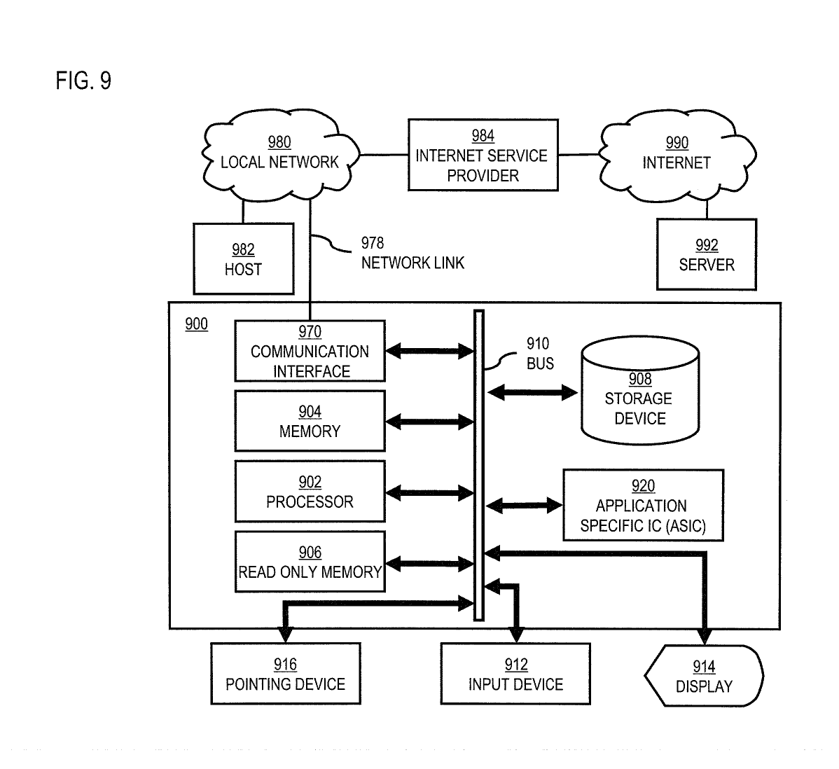

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to determine proximity of a user to a POI to dynamically adapt applications, content, and user incentive as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of determining proximity of a user to a POI to dynamically adapt applications, content, and user incentive.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to determine proximity of a user to a POI to dynamically adapt applications, content, and user incentive. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for determining proximity of a user to a POI to dynamically adapt applications, content, and user incentive. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for determining proximity of a user to a POI to dynamically adapt applications, content, and user incentive, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, which carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 111 for determining proximity of a user to a POI to dynamically adapt applications, content, and user incentive.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to determine proximity of a user to a POI to dynamically adapt applications, content, and user incentive as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of determining proximity of a user to a POI to dynamically adapt applications, content, and user incentive.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to determine proximity of a user to a POI to dynamically adapt applications, content, and user incentive. The memory 1005 also stores the data associated with or generated by the execution of the inventive steps.

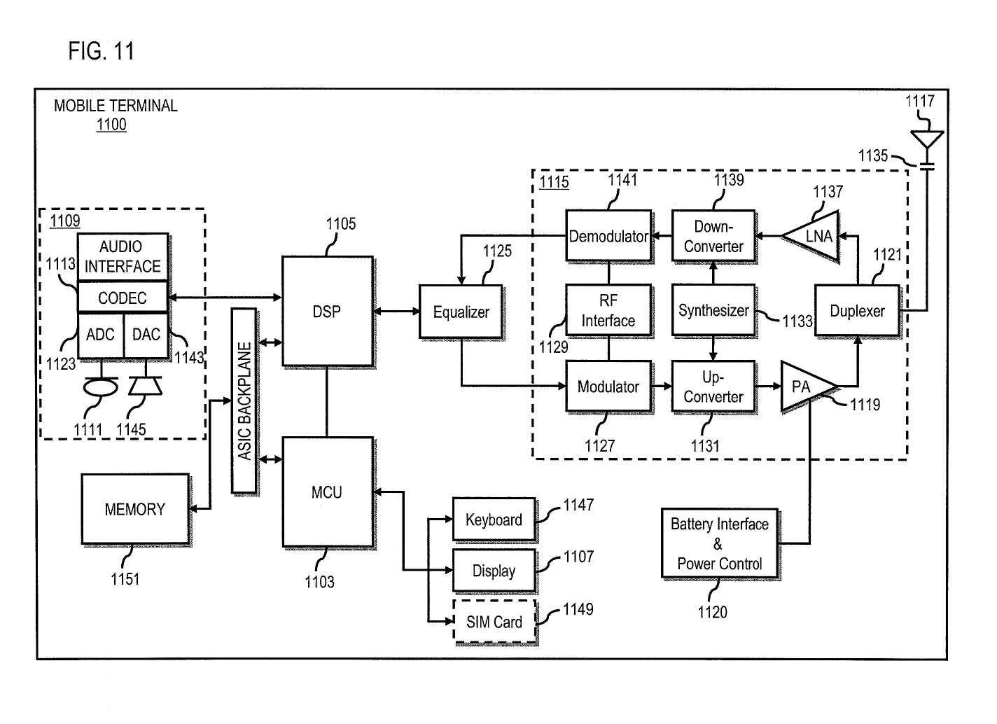

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of determining proximity of a user to a POI to dynamically adapt applications, content, and user incentive. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of determining proximity of a user to a POI to dynamically adapt applications, content, and user incentive. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to determine proximity of a user to a POI to dynamically adapt applications, content, and user incentive. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-53. (canceled)

54. A method comprising facilitating a processing of and/or processing (1) data and/or (2) information and/or (3) at least one signal, the (1) data and/or (2) information and/or (3) at least one signal based, at least in part, on the following:
at least one determination of a proximity of at least one device to at least one point of interest; and
at least one determination of at least one difficulty level associated with at least one application, at least one content item, or a combination thereof based, at least in part, on the proximity.

55. A method of claim 54, wherein the (1) data and/or (2) information and/or (3) at least one signal are further based, at least in part, on the following:
at least one determination of a utilization information for the at least one application, the at least one content item, or a combination thereof with respect to at least one user,
wherein the at least one difficulty level is further based, at least in part, on the utilization information.

56. A method of claim 55, wherein the (1) data and/or (2) information and/or (3) at least one signal are further based, at least in part, on the following:
a processing of the utilization information to determine at least one skill level associated with the at least one user,
wherein the at least one difficulty level is further based, at least in part, on the at least one skill level.

57. A method of claim 54, wherein the (1) data and/or (2) information and/or (3) at least one signal are further based, at least in part, on the following:
a recommendation of at least one path to the at least one point of interest to cause, at least in part, an adjustment of the at least one application, the at least one content item, or a combination thereof based, at least in part, on the at least one difficulty level.

58. A method of claim 57, wherein the (1) data and/or (2) information and/or (3) at least one signal are further based, at least in part, on the following:
at least one determination of one or more searches for the at least one point of interest; and
a presentation of the recommendation based, at least in part, on the one or more searches.

59. A method of claim 54, wherein the (1) data and/or (2) information and/or (3) at least one signal are further based, at least in part, on the following:
a presentation of at least one indicator via a user interface of the at least one device,
wherein the at least one indicator depicts, at least in part, a progression of the at least one difficulty level based, at least in part, on the proximity.

60. A method of claim 54, wherein the (1) data and/or (2) information and/or (3) at least one signal are further based, at least in part, on the following:
a presentation of at least one link to the at least one application, the at least one content item, or a combination thereof in a user interface.

61. A method of claim 54, wherein the (1) data and/or (2) information and/or (3) at least one signal are further based, at least in part, on the following:
at least one determination that the at least one difficulty level substantially meets a threshold difficulty level based, at least in part, on the proximity; and
a presentation of a notification message.

62. A method of claim 54, wherein the (1) data and/or (2) information and/or (3) at least one signal are further based, at least in part, on the following:
at least one determination that the at least one application, the at least one content item, or a combination thereof has been at least partially or substantially completed at the at least one level of difficulty; and
a presentation of information associated with the at least one point of interest.

63. A method of claim 54, wherein the (1) data and/or (2) information and/or (3) at least one signal are further based, at least in part, on the following:
at least one determination that at least one device has approached the at least one point of interest to within a threshold proximity; and
at least one determination of at least another difficulty level based, at least in part, on another proximity to at least another point of interest,
wherein the at the least another difficulty level is progressively based, at least in part, on the at least one difficulty level.

64. An apparatus comprising:
at least one processor; and
at least one memory including computer program code for one or more programs,
the at least one memory and the computer program code configured to, with the at least one processor, cause the apparatus to perform at least the following,
determine a proximity of at least one device to at least one point of interest; and
determine at least one difficulty level associated with at least one application, at least one content item, or a combination thereof based, at least in part, on the proximity.

65. An apparatus of claim 64, wherein the apparatus is further caused to:
determine utilization information for the at least one application, the at least one content item, or a combination thereof with respect to at least one user,
wherein the at least one difficulty level is further based, at least in part, on the utilization information.

66. An apparatus of claim 62, wherein the apparatus is further caused to:
process and/or facilitate a processing of the utilization information to determine at least one skill level associated with the at least one user,
wherein the at least one difficulty level is further based, at least in part, on the at least one skill level.

67. An apparatus of claim 64, wherein the apparatus is further caused to:
cause, at least in part, a recommendation of at least one path to the at least one point of interest to cause, at least in part, an adjustment of the at least one application, the at least one content item, or a combination thereof based, at least in part, on the at least one difficulty level.

68. An apparatus of claim 67, wherein the apparatus is further caused to:
determine one or more searches for the at least one point of interest; and
cause, at least in part, a presentation of the recommendation based, at least in part, on the one or more searches.

69. An apparatus of claim 64, wherein the apparatus is further caused to:
cause, at least in part, a presentation of at least one indicator via a user interface of the at least one device,
wherein the at least one indicator depicts, at least in part, a progression of the at least one difficulty level based, at least in part, on the proximity.

70. An apparatus of claim 64, wherein the apparatus is further caused to:
cause, at least in part, a presentation of at least one link to the at least one application, the at least one content item, or a combination thereof in a user interface.

71. An apparatus of claim 64, wherein the apparatus is further caused to:
determine that the at least one difficulty level substantially meets a threshold difficulty level based, at least in part, on the proximity; and
cause, at least in part, a presentation of a notification message.

72. An apparatus of claim 64, wherein the apparatus is further caused to:
determine that the at least one application, the at least one content item, or a combination thereof has been at least partially or substantially completed at the at least one level of difficulty; and
cause, at least in part, a presentation of information associated the at least one point of interest.

73. An apparatus of claim 64, wherein the apparatus is further caused to:
determine that at least one device has approached the at least one point of interest to within a threshold proximity; and
determine at least another difficulty level based, at least in part, on another proximity to at least another point of interest,
wherein the at the least another difficulty level is progressively based, at least in part, on the at least one difficulty level.
